(19) United States
(12) Patent Application Publication
(10) Pub. No.: US 2013/0057888 A1
(43) Pub. Date: Mar. 7, 2013

(54) INFORMATION PROCESSING APPARATUS, CONTROL METHOD FOR INFORMATION PROCESSING APPARATUS, AND STORAGE MEDIUM

(71) Applicant: Makoto Dohi, Naka-gun (JP)

(72) Inventor: Makoto Dohi, Naka-gun (JP)

(73) Assignee: CANON KABUSHIKI KAISHA, Tokyo (JP)

(21) Appl. No.: 13/597,066

(22) Filed: Aug. 28, 2012

(30) Foreign Application Priority Data
Sep. 1, 2011 (JP) 2011-190878

(51) Int. Cl. G06F 3/12

(52) U.S. Cl. 358/1.13

(57) ABSTRACT

An information processing apparatus capable of communicating with an image reading apparatus that reads an image of a document includes a determination unit configured to determine whether image data received from the image reading apparatus is image data read in a batch reading mode in which the image reading apparatus reads images of respective back surfaces of a plurality of documents after reading images of respective front surfaces of the plurality of documents, and a control unit configured to execute processing for changing a page order of the image data received from the image reading apparatus if the determination unit determines that the image data is image data read in the batch reading mode.

### BACKGROUND OF THE INVENTION

1. Field of the Invention

The present invention relates to an information processing apparatus, a control method for an information processing apparatus, and a storage medium.

2. Description of the Related Art

An image forming apparatus such as a copying machine or a multifunction peripheral includes an image reading apparatus that reads a document via a reading unit. The image forming apparatus performs image processing of the image data read by the image reading apparatus, prints the image data, and sends the read image data to an information processing apparatus.

The image reading apparatus with such a configuration includes an automatic document feeder that automatically feeds documents, which are stacked and placed thereon, one by one to the reading unit.

In an image reading apparatus without such an automatic document feeder, a user needs to set the documents one by one to allow the image reading apparatus to read the documents. This is excessively troublesome. Therefore, the automatic document feeder is greatly advantageous.

Some automatic document feeders have an automatic two-sided document feeding function for automatically reading two sides (a front surface and a back surface) of an input document via one reading unit. With such an automatic two-sided document feeding method, the reading unit first reads the front surface of the document. The front and back surfaces of the document are then reversed, and the reading unit reads the back surface of the document. If the document is directly discharged outside the image reading apparatus, the document is discharged in an opposite state of the front and back surfaces to the document before conveyance. After the back surface is read, the document is, therefore, reversed again, directions of the front and back surfaces of the document are returned to the state before the reading, and the document is discharged. As a consequence, the two sides of the document are automatically read without the troublesomeness of the user.

However, it takes a long time for which the document is not read at a document conveyance time for reversing the document after reading the front surface thereof or at a document conveyance time for reversing the document after reading the back surface thereof.

Japanese Patent Application Laid-Open No. 2006-327728 discusses the following technique for reducing a time for which a document is not read. The front surface of a first document is first read, and the front surface of a second document is then read while the first document is retracted for reversal. Then, the back surface of the first document is read while the second document is retracted to a position different from the retraction position of the first document in order to reverse the second document.

Then, the back surface of the second document is read while the first document is retracted to a position (third retraction position) different from the retraction position of the second document in order to reverse the first document again. Then, the first document is discharged outside the apparatus while the second document is moved to the third retraction position in order to reverse the second document again. Finally, the second document is discharged outside the apparatus from the third retraction position.

The second document is read for a time for reversing the first document by changing the reading order of the two-sided reading documents. As a consequence, the performance of the reading operation can be improved.

When document images are read in the order used for the method discussed in Japanese Patent Application Laid-Open No. 2006-327728, the reading order is different from the page order of documents. The front surface (third page) of a second document is read after the front surface (first page) of a first document is read. Then, the back surface (second page) of the first document and the back surface (fourth page) of the second document are sequentially read. For the purpose of output in normal order of the document images that are read in that order, images of a plurality of pages need to be temporarily stored in a storage unit, and the pages need to be rearranged.

However, there is the following problem when the image data of the document read by an image processing apparatus is sent to an information processing apparatus such as a personal computer (PC), and the image data is stored on the information processing apparatus side. Some image reading apparatuses may include a storage unit with a small capacity to reduce costs. In this case, the capacity is not sufficient to store the read image data containing a plurality of pages. Thus, the image data containing the plurality of pages cannot be temporarily stored, and cannot be output with rearrangement of the pages.

Then, the image data may be sent to the information processing apparatus in the reading order, and the information processing apparatus, receiving the image data, may directly store the image data. In this case, the image data is stored in an order different from the original page order of the documents. For example, the image data is stored in the order of the front surface (first page) of the first document, the front surface (third page) of the second document, the back surface (second page) of the first document, and the back surface (fourth page) of the second document. Therefore, the order of the second page and the third page is not correct.

In particular, if the information processing apparatus sets the received image data, as a file, in the order of the received pages and the file is then read and displayed, the image data is displayed in a page order different from the page order of the documents. A user can execute an application and can manually correct the page order in the file. In this case, it is troublesome for the user.

### SUMMARY OF THE INVENTION

According to an aspect of the present invention, an information processing apparatus capable of communicating with an image reading apparatus that reads an image of a document includes a determination unit configured to determine whether image data received from the image reading apparatus is image data read in a batch reading mode in which the image reading apparatus reads images of respective back surfaces of a plurality of documents after reading images of respective front surfaces of the plurality of documents, and a control unit configured to execute processing for changing a page order of the image data received from the image reading apparatus if the determination unit determines that the image data is image data read in the batch reading mode.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a block diagram of a configuration of an image processing system according to a first exemplary embodiment of the present invention.

FIG. 2 illustrates a cross-sectional view of an automatic document feeder included in a reading unit in FIG. 1.

FIG. 3 illustrates image reading examples of the reading unit according to the first exemplary embodiment.

FIG. 4 illustrates other image reading examples of the reading unit according to the first exemplary embodiment.

FIG. 5 illustrates a flowchart illustrating a control method for an information processing apparatus according to the first exemplary embodiment.

FIG. 6 illustrates a page structure of image data received by the information processing apparatus according to the first exemplary embodiment.

FIG. 7 illustrates another page structure of the image data received by the information processing apparatus according to the first exemplary embodiment.

FIG. 8 illustrates a flowchart illustrating a control method for an information processing apparatus according to a second exemplary embodiment of the present invention.

FIG. 9 illustrates a page structure of image data received by the information processing apparatus according to the second exemplary embodiment.

### DESCRIPTION OF THE EMBODIMENTS

Various exemplary embodiments, features, and aspects of the invention will be described in detail below with reference to the drawings.

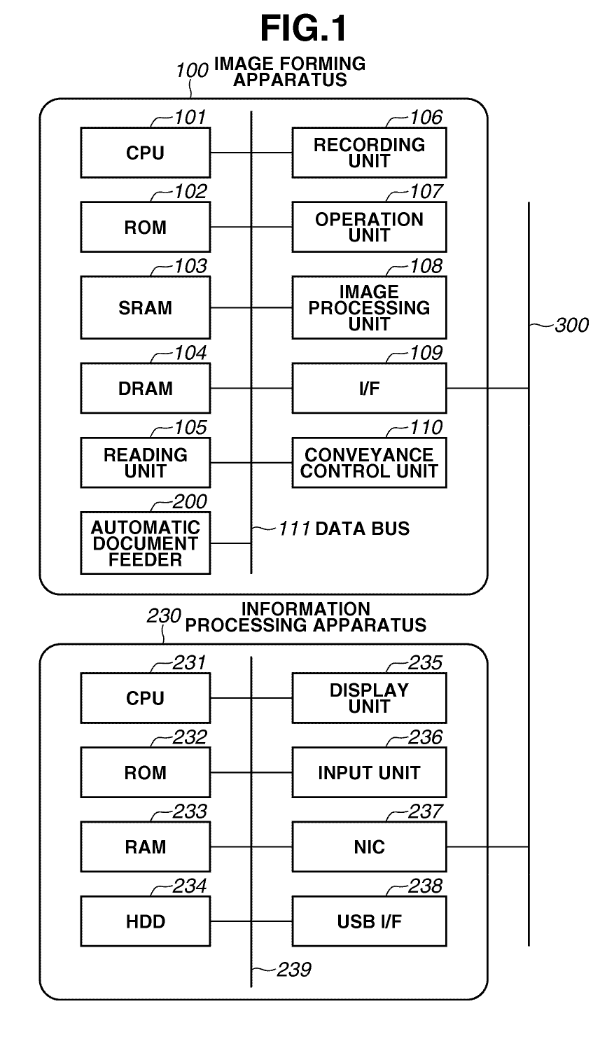

FIG. 1 illustrates a block diagram of a configuration of an image processing system, including an image forming apparatus 100 and an information processing apparatus 230, according to a first exemplary embodiment of the present invention. According to the first exemplary embodiment, an example of the image forming apparatus 100 including a reading unit 105 is illustrated. The reading unit 105 in the image forming apparatus 100 according to the first exemplary embodiment includes an automatic document feeder 200. The automatic document feeder 200 can perform high-speed reading. In the image processing system, the reading unit 105, which reads images of two sides, i.e., a front surface and a back surface, of a document, can communicate data with the information processing apparatus 230 via a network 300.

Referring to FIG. 1, a central processing unit (CPU) 101 executes a control program stored in a read only memory (ROM) 102 and thus controls units connected to a data bus 111. The ROM 102 stores the control program of the CPU 101. A static random access memory (SRAM) 103 stores a setting value or management data of a device registered by an operator, or data such as image data read by the reading unit 105. A dynamic random access memory (DRAM) 104 is mainly used as a work memory for the CPU 101 or a page buffer area for storing the image data and stores a program control variable. The reading unit 105 includes an image line sensor, reads an image of a conveyed document, A/D converts the read image, and generates image data (binary data). An automatic document feeder 200, which automatically feeds the document thereto in response to an instruction from the CPU 101, is provided for the reading unit 105. The automatic document feeder 200 reverses the document via a conveyance path in the automatic document feeder 200, reads and reverses the document to automatically read the front and back surfaces of the document, and discharges the document. When the document is read with a copy function, the read image data is output to a recording unit 106. The recording unit 106 prints and outputs the image data read by the reading unit 105 to a recording sheet.

An operation unit 107 includes a display unit that displays a state of the image forming apparatus 100, and buttons for setting the image forming apparatus 100 by a user, functioning as an interface unit with the user. An image processing unit 108 performs coding/decoding processing of image data used for a copying operation. The image processing unit 108 also includes a scaling unit for the copy image.

An interface (I/F) 109 is used for communication with the external information processing apparatus 230 via a local area network (LAN) including the Ethernet or a universal serial bus (USB). A conveyance control unit 110 includes a conveyance roller and a motor that drives the conveyance roller. The units are connected to the CPU 101 via a data bus 111, and the image data is transferred to the conveyance control unit 110 or the recording unit 106 via the data bus 111.

The information processing apparatus 230 is connected to the image forming apparatus 100 via the network 300 for communication. A central processing unit (CPU) 231 loads a control program or an application program stored in a read only memory (ROM) 232 or a hard disk drive (HDD) 234 to a random access memory (RAM) 233, and performs various processing. A display unit 235 includes a liquid crystal display (LCD), and displays various user interface screens via an application or a browser. An input unit 236 includes a keyboard and a pointing device.

A network interface controller (NIC) 237 performs reception processing of configuration information or image data acquired from the image forming apparatus 100 via the network 300. The NIC 237 further sends a command for enabling the reading unit 105 in the image forming apparatus 100 to function as a remote scanner to the image forming apparatus 100 in response to an instruction from the CPU 231. Various universal serial bus (USB) devices including a USB memory can be connected to a USB interface (I/F) 238. An internal bus 239 connects the units to the CPU 231. The HDD 234 stores various programs or the image data. A scanner driver is installed on the HDD 234 to enable the reading unit 105 in the image forming apparatus 100 to function as a network scanner.

In the information processing apparatus 230 with the above-described configuration, when the CPU 231 receives the image data from the image forming apparatus 100, the CPU 231 can store the image data without or with change of a page order of the image data. The CPU 231 stores the image data in the HDD 234 by using the RAM 233 as a buffer. The page order of the image data stored in the HDD 234 may be changed. Alternatively, the page order of the image data stored in the RAM 233 maybe changed. Thereafter, the CPU 231 sends the image data to the application, so that image processing of the image data is performed with the application in the normal page order. The information processing apparatus 230 can store reception data of a plurality of pages for reception as one file, or can respectively store reception data of a plurality of received pages as page data.

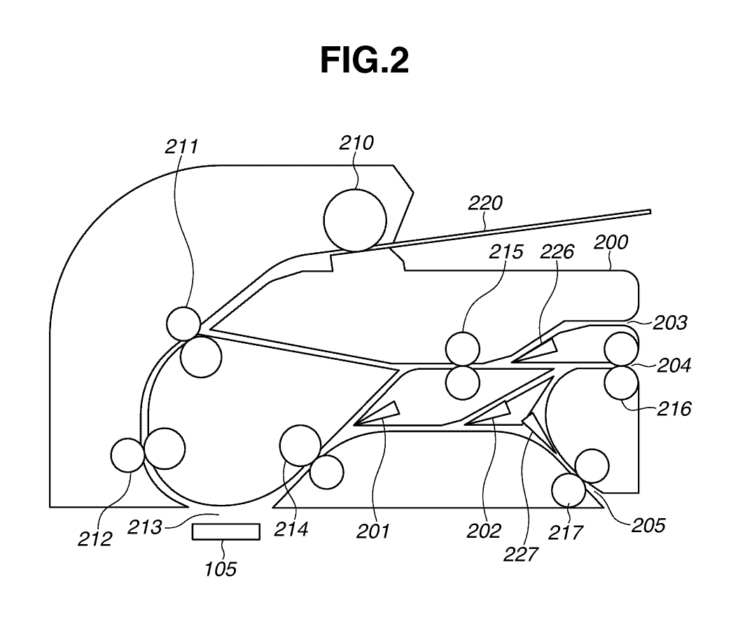

FIG. 2 illustrates a cross-sectional view of a configuration of the automatic document feeder 200 provided for the reading unit 105 in the image forming apparatus 100 in FIG. 1. In an example in FIG. 2, the automatic document feeder 200 includes a plurality of sheet conveyance paths, and switches the conveyance paths with flappers (diverters).

Referring to FIG. 2, the document is placed on a document positioning plate 220. Then, the user presses a reading start button on the operation unit 107. The CPU 101 drives rollers 210, 211, and 212 with the conveyance control unit 110 to convey the document. The CPU 101 enables a reading unit 213 to read the document when the document passes through the reading unit 105. Thereafter, the CPU 101 conveys the document via the rollers 214. The CPU 101 controls an operation for setting a flapper 201 moved down so that the document passes through an upper conveyance path. Thereafter, the CPU 101 conveys the document via rollers 215. The CPU 101 also controls an operation for setting a flapper 226 moved down to convey the document to an upper reversal exit 203, and temporarily retracts the document to the upper reversal exit 203 while the rollers 215 sandwich a near portion of a trailing edge in the conveyance direction of the document for conveyance. The CPU 101 inversely rotates the rollers 215 with the conveyance control unit 110 (that is, clockwise rotates the rollers 215 as illustrated in FIG. 2), and conveys the document with the rollers 215, 211, and 212. When the document passes through the reading unit 105, the CPU 101 enables the reading unit 105 to read the back surface of the document. The CPU 101 further controls an operation for setting a flapper 201 moved up. Further, the CPU 101 controls an operation for setting a flapper 202 moved up, and enables the document whose back surface is read to be conveyed toward a re-reversal exit 205. The CPU 101 retracts the document, whose reading of the back surface ends, to the re-reversal exit 205 with a trailing edge of the document in the conveyance direction sandwiched between rollers 217. Thereafter, the CPU 101 controls an operation for setting a flapper 227 moved down, and enables the conveyance control unit 110 to inversely rotate the rollers 217 (that is, to clockwise rotate the rollers 217 as illustrated in FIG. 2) to shift the document toward a lower reversal exit 204. Finally, the CPU 101 discharges the document, whose reading of the back surface ends, from the lower reversal exit 204 outside the image forming apparatus 100 via the rollers 217 and 216. This is document conveyance control based on a first conveyance path system.

A second conveyance path is described below. The document is first placed on the document positioning plate 220. Then, the CPU 101 drives the rollers 210, 211, and 212 with the conveyance control unit 110 to convey the document, and enables the reading unit 213 to read the document when the document passes through the reading unit 105. Thereafter, the CPU 101 also conveys the document via the rollers 214. The CPU 101 controls an operation for setting the flapper 201 moved up, and also controls an operation for setting the flapper 202 moved down. As a consequence, the CPU 101 conveys the document toward the lower reversal exit 204. The document is then conveyed up to the rollers 216. Then, the CPU 101 enables the rollers 216 to sandwich a near portion of the trailing edge of the document in the conveyance direction to temporarily retract the document to the lower reversal exit 204. The CPU 101 enables the conveyance control unit 110 to inversely rotate the rollers 216 (that is, clockwise rotate the roller 216 as illustrated in FIG. 2) and convey the document toward the rollers 215. The CPU 101 drives the rollers 215, 211, and 212 with the conveyance control unit 110, and enables the reading unit 105 to read an image of the back surface of the document when the document passes through the reading unit 105. The CPU 101 controls an operation for setting the flapper 201 moved up, and also controls an operation for the flapper 202 moved up. The CPU 101 also controls an operation for conveying the document toward the rollers 217 and retracting the document to the lower re-reversal exit 205 via the rollers 217. Further, the CPU 101 enables the rollers 215 to sandwich the trailing edge of the document in the conveyance direction, and controls an operation for setting the flapper 227 moved down. The CPU 101 inversely conveys the document, and externally discharges the document to the outside from the lower reversal exit 204 via the rollers 217 and 216.

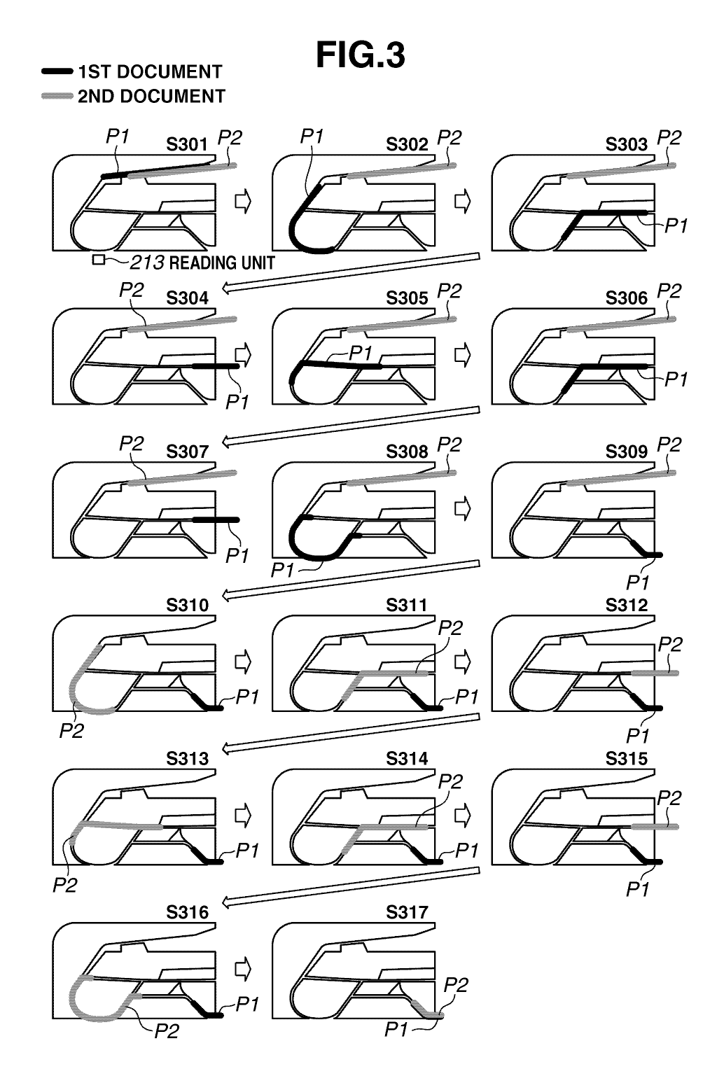

A description is given of an operation of the reading unit 213 when a “normal order reading mode” is executed to read, in a normal order, the front and back surfaces of the document in the automatic document feeder 200 in FIG. 2 with reference to FIG. 3.

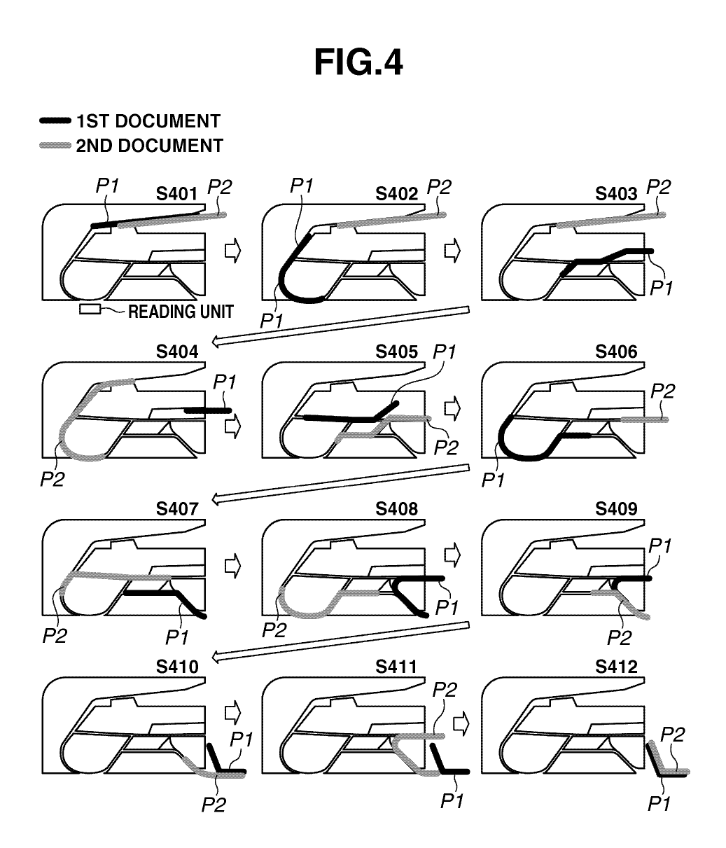

FIGS. 3 and 4 illustrate document conveyance states of the reading unit 105 in FIG. 2. In the following description, a first document P1 indicated by black thick lines is first read, and a second document P2 indicated by gray thick lines is secondly read. S301 to S317 indicate document conveyance steps.

Referring to FIG. 3, the two documents P1 and P2 are stacked and placed on the automatic document feeder 200 with the front surfaces thereof facing upward. In that state, the user presses the reading start button on the operation unit 107. Then, the two-sided reading of the document starts. In step S301, the rollers 210, 211, and 212 are driven and the first document P1 is thus conveyed on the conveyance path.

In step S302, the first document P1 passes through the reading unit 213 while the front surface thereof is moved down, and the front surface of the first document P1 is read. When the reading of the front surface of the first document P1 ends, the first document P1 is reversed to read the back surface of the first document P1.

In steps S303 and S304, the first document P1 is first fed once, and the state enters reversing preparation. In step S305, the first document P1 is conveyed toward the reading unit 213 to read the back surface of the first document P1. In this instance, the back surface of the first document P1 faces upward, and the first document P1 in FIG. 3 is conveyed with the left edge thereof set in the head direction of the conveyance one. In step S306, the first document P1 is fed along the conveyance path, and passes through the reading unit 213 while the back surface thereof faces downward, and the back surface thereof is read. The reading of the front and back surfaces of the first document P1 ends. If the first document P1 is directly discharged outside the image forming apparatus 100 in this state, the first document P1 is discharged in an opposite order of that of the documents placed on the document positioning plate 220. Therefore, the first document P1 is reversed again before being discharged. In step S307, the first document P1 enters reversing preparation. In step S308, the first document P1 passes through the conveyance path, and the first document P1 is reversed again. In step S309, the first document P1 finally passes though the conveyance path for discharge and is discharged outside the image forming apparatus 100.

In step S310, the reading of the front and back surfaces of the first document P1 ends, and the reading of the second document P2 starts. In steps S310 to S317, the two-sided reading of the second document P2 is similar to that of the first document P1, and is not described again. As described above, the two-sided reading in the “normal order reading mode” is realized by reading the front surface of the document, reversing the document, reading the back surface of the document, reversing the document again, and discharging the document in this order for each document.

In the “normal order reading mode”, it takes a long time for which the document is not read by the reading unit 213.

Specifically, in the “normal order reading mode”, the image of the document is read in the page order of the document images. Therefore, it takes a long time in steps S303 to S305 of reading the front surface of the document by the reading unit 213, then reversing the document, and starting to read the back surface thereof.

In the example in the “normal order reading mode”, in steps S306 to S308 of reversing the document again after reading the back surface of the document, the same conveyance path as that of the conveyance path through which the second document P2 passes is used. The next document is not read while the document is reversed again. This causes deterioration in reading efficiency.

In order to more efficiently read the document than the “normal order reading mode”, there is a “batch reading mode” in which the front surfaces of a plurality of documents are continuously read and the back surfaces of the plurality of documents are thereafter continuously read. According to the present exemplary embodiment, the “normal order reading mode” is referred to as a first reading mode, and the “batch reading mode” is referred to as a second reading mode.

The two-sided reading in the “batch reading mode” is described with reference to FIG. 4.

The user stacks and places two documents on the automatic document feeder 200 while the front surfaces of the documents face upward, and instructs the reading unit 213 to perform the two-sided reading. When the start of the two-side reading is instructed, in step S401, the first document P1 is conveyed. In step S402, the first document P1 passes through the reading unit 231 with the front surface of the first document P1 facing downward, so that the front surface of the first document P1 is read. Thus, the reading of the front surface of the first document P1 ends.

The reading unit 231 reverses the first document P1 to read an image of the back surface of the first document P1. Therefore, the first document P1 is first temporarily fed and the state enters the reversing preparation. In this instance, the CPU 101 and the conveyance control unit 110 control the position of the flappers so that the first document P1 passes through an upper conveyance path. In step S403, the second document P2 is conveyed to read the front surface of the second document P2.

In step S404, the reading unit 213 reads the front surface of the second document P2 while conveying the first document P1. The reversed first document P1 is conveyed toward the reading unit 213 again to read the back surface of the first document P1. Simultaneously, the second document P2 is also first reversed to read the back surface thereof. In step S405, the CPU 101 controls the position of the flapper so that the second document P2 passes through a lower conveyance path so that the back surface of the first document P1 faces upward and is then conveyed to move the trailing edge of the first document P1 toward the head direction of the conveyance one.

The first document P1 is fed along the conveyance path, and passes through the reading unit 213 again so that the back surface of the first document P1 faces downward to read the back surface thereof. In step S406, the second document P2 is first fed and is revered. The reading of the front and back surfaces of the first document P1 ends. Then, the first document P1 is reversed again. In step S407, the first document P1 passes through the reading unit 213, and further passes a lowest conveyance path and is reversed again, the back surface of the second document P2 faces upward and is further conveyed to move the tailing edge of the second document P2 toward the head of the conveyance direction, and the reading of the back surface thereof starts.

In step S408, the first document P1 is reversed in the conveyance path for re-reversal, and the reading unit 213 reads the back surface of the second document P2. In step S409, the first document P1 is subjected to an operation for discharging the document after the reversal, and the second document P2 enters a conveyance path for re-reversal and is further reversed. In steps S410 to S412, the first document P1 is thereafter discharged outside the image forming apparatus 100, and the second document P2 is reversed and is also discharged outside the image forming apparatus 100.

In the “batch reading mode”, the second document P2 is conveyed for a period for reversing the front and back surfaces of the first document P1, and the image of the conveyed second document P2 is read, thereby realizing high reading efficiency.

In the “normal order reading mode”, images are read in the order of the front surface of the first document P1, the back surface of the first document P1, the front surface of the second document P2, the back surface of the second document P2, the front surface of a third document, the back surface of the third document, . . . .

On the other hand, in the “batch reading mode”, images are read in the order of the front surface of the first document P1, the front surface of the second document P2, the back surface of the first document P1, the back surface of the second document P2, the front surface of the third document, the front surface of the fourth document, . . . . This order is expressed by pages, that is, the first page, the third page, the second page, the fourth page, . . . . After that, the order of a plurality of documents is the fifth page, the seventh page, the sixth page, the eighth page, the ninth page, the eleventh page, the tenth page, the twelfth page, . . . . Images of the plurality of pages need to be rearranged to output, in a normal order, the images of the documents read in the above-described order.

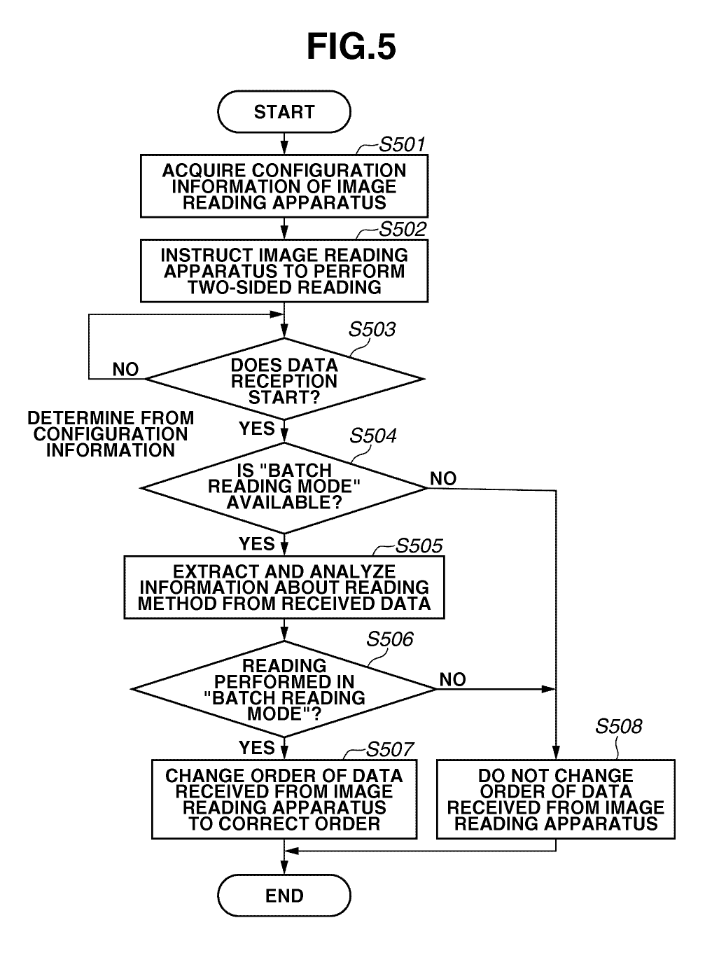

A description is given of a sequence of sending processing of the image data read by the reading unit 105 and filing the image data (hereinafter, referred to as a remote scanning operation) with reference to a flowchart in FIG. 5 and FIGS. 6 and 7.

FIG. 5 illustrates a flowchart of a control method for the information processing apparatus 230 according to the first exemplary embodiment. In a transfer control example in FIG. 5, the reading unit 213 included in the image forming apparatus 100 transfers the read image data to the information processing apparatus 230 provided outside, as remote scanning processing. Steps are realized by loading a control program stored in the ROM 232 to a memory and executing the program by the CPU 231 of the information processing apparatus 230.

In order to start the remote scanning operation, the document whose image is to be read by the reading unit 105 is placed on the document positioning plate 220 of the automatic document feeder 200, and processing necessary for the remote scanning processing is sequentially performed from the information processing apparatus 230 side provided outside.

A description is given of the remote scanning operation from the information processing apparatus 230 connected via the I/F 109 provided for the image forming apparatus 100 in the processing. An example is described about processing for changing the order of the image data received from the image forming apparatus 100 by the information processing apparatus 230 and arranging the page order.

In the remote scanning operation, the information processing apparatus 230 instructs the reading unit 105 to send the configuration information to the information processing apparatus 230 to recognize which device constitutes the reading unit 105 included in the image forming apparatus 100. In step S501, the information processing apparatus 230 acquires the configuration information sent by the reading unit 105 in response to the instruction. Further, the information processing apparatus 230 stores the configuration information of the reading unit 105 in a storage unit (not illustrated) in the information processing apparatus 230.

The configuration information includes information (including, e.g., the reading mode) about which device or function the image forming apparatus 100 includes. The CPU 231 may receive the configuration information of the image forming apparatus 100, and may acquire the configuration information of the reading unit 105 included in the configuration information of the image forming apparatus 100.

Specifically, the configuration information includes information about whether the reading unit 105 is provided for the automatic document feeder 200 and whether the automatic document feeder 200 has the two reading modes (“normal order reading mode” and “batch reading mode”).

The information processing apparatus 230 instructs the image forming apparatus 100 to read the document. In step S501, the information processing apparatus 230 checks whether it is described whether the reading unit 105 can read the two-sided document in the configuration information received from the reading unit 105 and stored therein. In step S502, the CPU 231 of the information processing apparatus 230 instructs the image forming apparatus 100 to read the two surfaces of the document.

When the start to execute the remote scanning of the document placed on the document positioning plate 220 is instructed via the input unit 236 of the information processing apparatus 230, the instruction is sent from the information processing apparatus 230 to the image forming apparatus 100. In step S503, the CPU 231 of the information processing apparatus 230 waits for the image data of the document to be sent from the image forming apparatus 100.

If the CPU 231 of information processing apparatus 230 determines that any data including the image data is not sent from the image forming apparatus 100 for a predetermined time (NO in step S503), the information processing apparatus 230 determines that the image forming apparatus 100 is abnormal and then performs processing for indicating an error to the user. The information processing apparatus 230 cancels the remote scanning operation of the image forming apparatus 100.

If the CPU 231 of the information processing apparatus 230 determines that the image data is sent from the image forming apparatus 100 (YES in step S503), then in step S504, the information processing apparatus 230 checks the stored configuration information of the reading unit 105 again to determine whether the “batch reading mode” is available for the reading unit 105. Specifically, the CPU 231 determines, based on the configuration information acquired from the image forming apparatus 100, whether the reading unit 105 of the image forming apparatus 100 is capable of performing reading in the “batch reading mode” for continuously reading a plurality of images on the front surface side or the back surface side.

If the CPU 231 of the information processing apparatus 230 determines that the “batch reading mode” is available (YES in step S504), the processing advances to step S505. If the CPU 231 of the information processing apparatus 230 determines that the “batch reading mode” is not available (NO in step S504), the processing advances to step S508 (step S508 is described below).

In step S505, the CPU 231 of the information processing apparatus 230 analyzes information about a reading mode (not illustrated) added to the image data sent from the image forming apparatus 100. The information about the reading mode indicates in which reading mode the image data sent from the image forming apparatus 100 has been actually read.

If the user issues an instruction to read the image data in the “batch reading mode” via the operation unit 107, information indicating that the image of the document has been read in the “batch reading mode” is added to the image data. If the user issues an instruction to read the image in the “normal order reading mode” via the operation unit 107, information indicating the image of the document has been read in the “normal order reading mode” is added to the image data. If the reading unit 105 of the automatic document feeder 200 partly fails and the document cannot be read in the “batch reading mode” so that the image is read in the “normal order reading mode”, the information indicating that the image of the document is read in the “normal order reading mode” is added to the image data.

Under the situation, if the determination is performed by using only the configuration information of the reading unit 105, and the information processing apparatus 230 performs processing in step S507, the document read in the “normal order reading mode” may be actually processed as the document read in the “batch reading mode”.

Although the document read in the “normal order reading mode” does not need specific processing, unnecessary processing may be performed and contents of a finally generated file (a file generated based on the image data sent from the image forming apparatus 100) may not be correct.

Therefore, if it is determined as an analysis result of the document reading mode performed by the CPU 231 that the reading unit 105 reads the document in the “batch reading mode” (YES in step S506), the processing advances to step S507. If it is determined as the analysis result of the document reading mode performed by the CPU 231 that the reading unit 105 does not read the document in the “batch reading mode” (that is, the reading unit 105 reads the document in the “normal order reading mode”) (NO in step S506), the processing advances to step S508.

In step S507, the information processing apparatus 230 performs the following page changing processing. Then, the processing ends.

Specifically, in step S507, the CPU 231 of the information processing apparatus 230 determines that the image data sent by the image forming apparatus 100 is acquired by reading the two-sided document in the “batch reading mode”. In this case, the image data is arranged in the order of the front surface of the first document, the front surface of the second document, the back surface of the first document, the back surface of the second document, . . . .

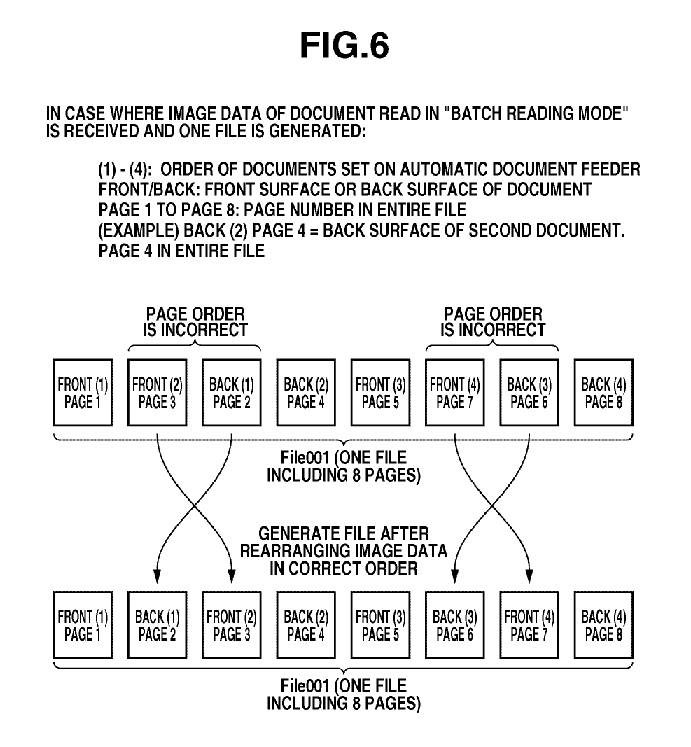

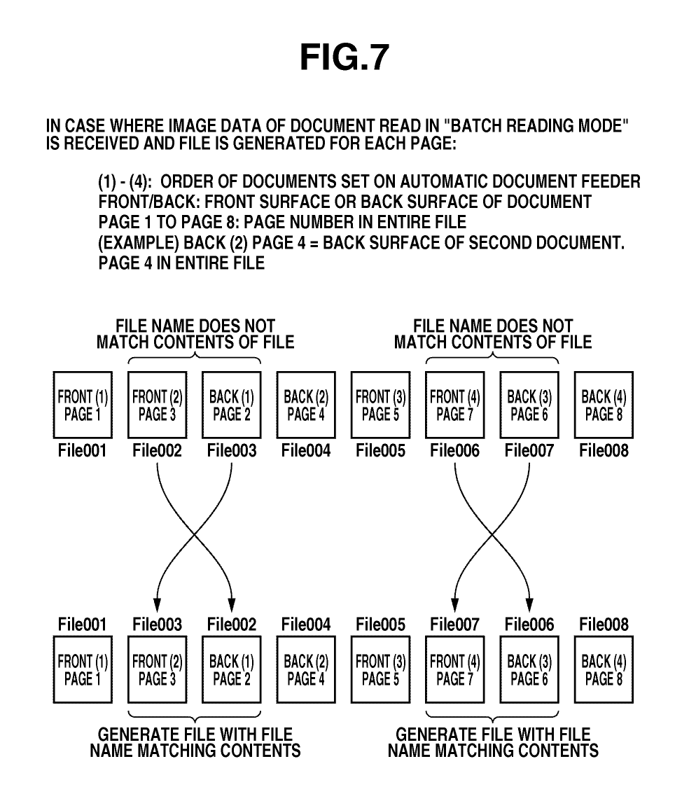

If the image data in the above-described order is converted into a file, two problems occur as illustrated in FIGS. 6 and 7.

FIGS. 6 and 7 illustrate page structures of the image data received by the information processing apparatus 230 according to the present exemplary embodiment. A description is given of page changing states with the image data received from the image forming apparatus 100 in the “batch reading mode”. Referring to FIGS. 6 and 7, (1) to (4) indicate the order of documents.

When the reading unit 105 reads two-sided images from a plurality of documents in the “batch reading mode”, the page order does not match the normal order if the image data is converted into a file.

Specifically, when the two-sided documents are read in the “batch reading mode”, the back surface of the first document (i.e., the second page in the entire file) is changed with the front surface of the second document (i.e., the third page in the entire file), as illustrated in top images with page arrangement in FIG. 6.

Similarly, the back surface of the third document (i.e., the sixth page in the entire file) is changed with the front surface of the fourth document (i.e., the seventh page in the entire file).

If the reading unit 105 reads the two-sided images of a plurality of documents in the “batch reading mode”, the page order does not match the normal order when the image data is converted into one file for every page.

Specifically, as illustrated in top images with arrangement of file names in FIG. 7, as File002, the image data of the back surface of the first document (i.e., the second page in the entire file) is to be originally converted into a file. However, there is actually a problem that contents of File002 are converted into a file as the image data of the front surface of the second document (i.e., the third page in the entire file).

Similarly, as File006, the image data of the back surface of the third document (i.e., the sixth page in the entire file) is to be originally converted into a file. However, contents of File006 are actually converted into a file as the image data of the front surface of the fourth document (i.e., the seventh page in the entire file). Both the order and the contents are changed once per two documents.

In order to cope with the state, according to the present exemplary embodiment, the following control is performed. In step S507 in FIG. 5, if the image data in FIG. 6 is set to be converted into a file, the arrangement order of the image data received from the image forming apparatus 100 is changed to the normal order of pages. Specifically, when the image data received from the image forming apparatus 100 is set as one file, the CPU 231 of the information processing apparatus 230 rearranges the image data in a page order illustrated in bottom images in FIG. 6 and sets the rearranged image data as one file.

The following is performed in a case where the user sets execution of respectively converting the image data for each page into a file as illustrated in FIG. 7. In step S507 in FIG. 5, the CPU 231 of the information processing apparatus 230 assigns file names in the order of File001→File003→File002→File004 to the image data sent from the image forming apparatus 100. The CPU 231 handles the image data by changing the assignment order of the file names for the change of the image data.

The user may previously set, via the input unit 236, whether the received image data is converted into a file or the image data is respectively converted into a file for each page.

In step S508, shifting from step S506, the image data sent from the reading unit 105 is image data acquired by reading the document in the “normal order reading mode” by the reading unit 105. Specifically, the pages of the image data are normally arranged in the order of the front surface of the first document→the back surface of the first document→the front surface of the second document→the back surface of the second document, . . . . In step S508, the processing ends without changing the page order or the assignment of the file names.

As a consequence, even if the page order is changed depending on the document reading mode when the image is read from the two-sided document, the image data in the normal page order can be received on the reception side without changing the document reading mode of the reading unit 105 or the sending order of the image data.

According to the first exemplary embodiment, the reading unit 105 sends the information (information about the document reading mode) indicating whether the document has been read in the “normal order reading mode” or the “batch reading mode” to the information processing apparatus 230.

On the other hand, the image forming apparatus 100 recognizes to which page in the entire file the number of the page read by the reading unit 105 corresponds. Therefore, a similar advantage is obtained by adding the page number to each page and sending the added page number to the information processing apparatus 230.

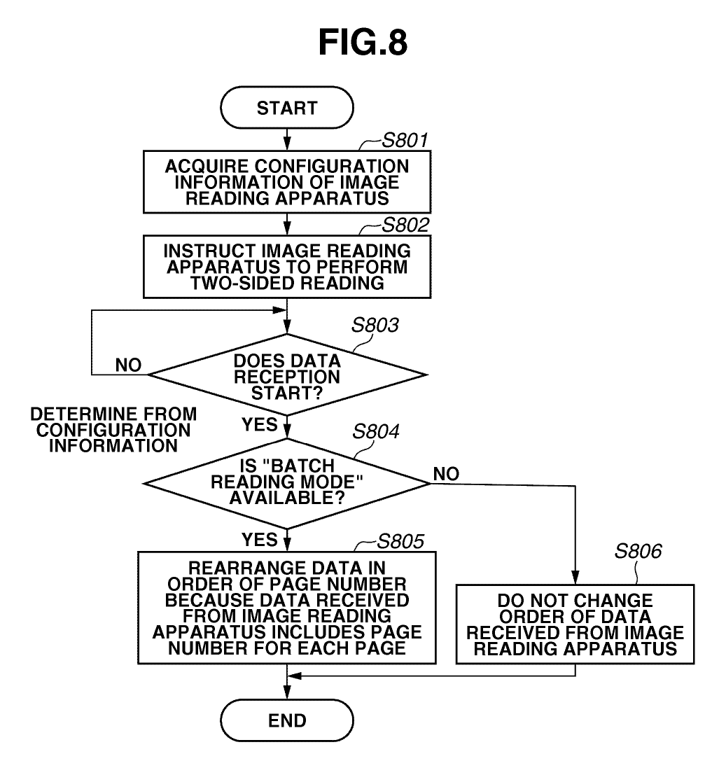

FIG. 8 illustrates a flowchart of a control method for the information processing apparatus 230 according to a second exemplary embodiment of the present invention. In a transfer control example in FIG. 8, the reading unit 105 transfers the read image data to the information processing apparatus 230 provided outside, as remote scanning processing. Steps are realized by loading a control program stored in the ROM 232 to a memory and executing the loaded program by the CPU 231 of the information processing apparatus 230. A description is given of processing for setting, as reception data, the image data after the information processing apparatus 230 performs processing for changing the order of the image data received from the image forming apparatus 100 to the normal order of pages.

In step S801, the CPU 231 of the information processing apparatus 230 acquires configuration information of the reading unit 105 via the network 300 and stores the information in an internal memory. In step S802, the CPU 231 of the information processing apparatus 230 instructs the reading unit 105 to read the two-sided document based on the information acquired from the reading unit 105. In step S803, the CPU 231 of the information processing apparatus 230 waits for the image data read from the document to be sent from the image forming apparatus 100.

When the image data is sent from the image forming apparatus 100, then in step S804, the CPU 231 of the information processing apparatus 230 checks the configuration information of the reading unit 105 stored in the internal memory again to determine whether the “batch reading mode” is available for the reading unit 105. The processing in steps S801 to S804 is similar to that in steps S501 to S504 according to the first exemplary embodiment.

If the CPU 231 of the information processing apparatus 230 determines that the “batch reading mode” is available (YES in step S804), the processing advances to step S805. If the CPU 231 of the information processing apparatus 230 determines that the “batch reading mode” is not available (NO in step S804), the processing advances to step S806.

In step S806, since the image data of the document read in the “normal order reading mode” by the reading unit 105 has been sent in the same order as the page order of the document, the information processing apparatus 230 converts the image data into a file without the processing for changing the pages. Then, the processing ends.

If the CPU 231 of the information processing apparatus 230 determines that the “batch reading mode” is available (YES in step S804), since the read image data of the document in the “batch reading mode” has been sent, the sent page order of the image data may be different from the actual page order of the document.

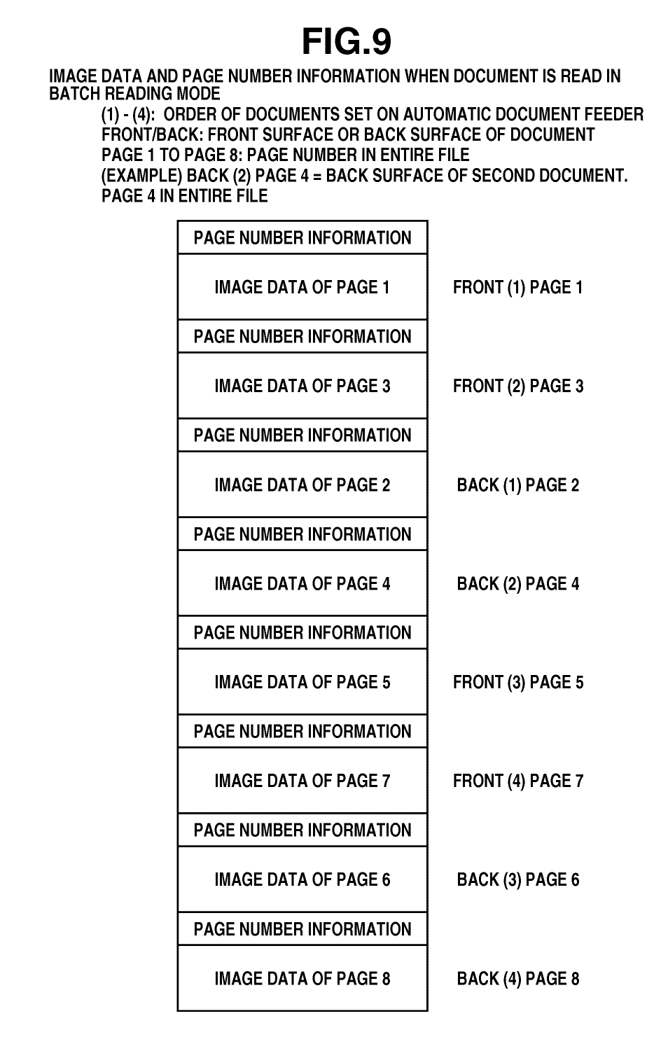

However, since the reading unit 105 recognizes to which page in the entire file the read page number corresponds, the reading unit 105 adds the page number to each page in a data format as illustrated in FIG. 9, and sends the image data to the information processing apparatus 230. Accordingly, the information processing apparatus 230 rearranges the image data in the order of page numbers added to the pages of the image data, thereby converting the image data into a file in the same order as the page order of the document.

According to the present exemplary embodiment, the CPU 231 acquires the page information about the image data from the image forming apparatus 100 in a state in which the CPU 231 determines that the “batch reading mode” is available. The CPU 231 changes the page order of the image data received from the reading unit 105 according to the acquired page information, and stores the image data in the normal page order. If the CPU 231 determines that the “batch reading mode” is not available, the image data is received from the reading unit 105 in the normal page order. Therefore, the image data is stored without changing the page order.

As a consequence, although the page order is changed depending on the document reading mode when the image is read from the two sided document, the image data in the normal page order can be received on the reception side without changing the document reading mode of the reading unit 105 or the sending order of the image data.

According to the above-described exemplary embodiments, the information processing apparatus 230 instructs the image forming apparatus 100 to perform the remote scanning for receiving the image data from the image forming apparatus 100. However, the present invention is not limited to the remote scanning, and the image forming apparatus 100 can send the image data to the information processing apparatus 230 in response to an instruction input via the operation unit 107. The image forming apparatus 100 may not include the recording unit 106 but may include the single reading unit 105.

Steps according to the exemplary embodiments of the present invention can be realized by executing software (program) acquired via a network or various storage media by a processing apparatus (a central processing unit (CPU) or a processor) such as a personal computer (PC) (computer).

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-190878 filed Sep. 1, 2011, which is hereby incorporated by reference herein in its entirety.

What is claimed is:

1. An information processing apparatus capable of communicating with an image reading apparatus that reads an image of a document, the information processing apparatus comprising:
a determination unit configured to determine whether image data received from the image reading apparatus is image data read in a batch reading mode in which the image reading apparatus reads images of respective back surfaces of a plurality of documents after reading images of respective front surfaces of the plurality of documents; and
a control unit configured to execute processing for changing a page order of the image data received from the image reading apparatus if the determination unit determines that the image data is image data read in the batch reading mode.

2. The information processing apparatus according to claim 1, wherein the control unit is configured not to execute the processing for changing the page order of the image data received from the image reading apparatus if the determination unit does not determine that the image data is image data read in the batch reading mode.

3. The information processing apparatus according to claim 1, further comprising a checking unit configured to check whether the image reading apparatus is capable of reading in the batch reading mode, and
wherein the determination unit is configured to determine whether the image data is image data read in the batch reading mode if the checking unit determines that the image reading apparatus is capable of reading in the batch reading mode.

4. The information processing apparatus according to claim 1, wherein the control unit is configured to convert the image data, whose page order has been changed, into one file.

5. The information processing apparatus according to claim 1, wherein the control unit is configured to execute, as the processing for changing the page order, an order of an image of the back surface of an n-th document and an image of the front surface of an (n+1)th document.

6. An information processing apparatus capable of communicating with an image reading apparatus that reads an image of a document, the information processing apparatus comprising:
a determination unit configured to determine whether image data received from the image reading apparatus is image data read in a batch reading mode in which the image reading apparatus reads images of respective back surfaces of a plurality of documents after reading images of respective front surfaces of the plurality of documents; and
a control unit configured to execute processing for changing a page order of the image data received from the image reading apparatus according to page information of the image data received from the image reading apparatus if the determination unit determines that the image data is image data read in the batch reading mode.

7. The information processing apparatus according to claim 6, further comprising a checking unit configured to check whether the image reading apparatus is capable of reading in the batch reading mode, and
wherein the determination unit is configured to determine whether the image data is image data read in the batch reading mode if the checking unit determines that the image reading apparatus is capable of reading in the batch reading mode.

8. The information processing apparatus according to claim 6, wherein the control unit is configured to convert the image data, whose page order has been changed, into one file.

9. A control method for an information processing apparatus capable of communicating with an image reading apparatus that reads an image of a document, the control method comprising:
determining whether image data received from the image reading apparatus is image data read in a batch reading mode in which the image reading apparatus reads images of respective back surfaces of a plurality of documents after reading images of respective front surfaces of the plurality of documents; and
executing processing for changing a page order of the image data received from the image reading apparatus if it is determined that the image data is image data read in the batch reading mode.

10. A computer-readable storage medium storing a program that causes a computer to execute the control method according to claim 9.
